(19) United States
(12) Patent Application Publication
(10) Pub. No.: US 2013/0320604 A1
(43) Pub. Date: Dec. 5, 2013

(54) Viscous-Fluid-Enclosing Damper and Vibration-Damping Composition

(71) Applicant: Polymatech Japan Co., Ltd., Saitama (JP)

(72) Inventors: Junji Ohki, Tokyo (JP); Akira Naito, Tokyo (JP)

(21) Appl. No.: 13/903,126

(22) Filed: May 28, 2013

(30) Foreign Application Priority Data
May 30, 2012 (JP) 2012-123101

(51) Int. Cl. F16F 13/08

(52) U.S. Cl. CPC F16F 13/08
USPC 267/140.11; 524/585; 524/606

(57) ABSTRACT

Provided is a viscous-fluid-enclosing damper which attenuates, by using viscous resistance of a vibration-damping composition, vibrations transmitted between a support and an object to be supported, the support and object being attached to a closed container enclosing the vibration-damping composition of a viscous fluid. The viscous-fluid-enclosing damper alters few vibration-damping properties even when used under high temperatures and/or conditions where the vibrations are repeatedly generated for a prolonged period. Also provided is the vibration-damping composition which is used for the viscous-fluid-enclosing damper. The viscous fluid contains a viscous liquid having dispersed therein at least one type of heat-resistant resin particles and a dripping inhibitor, the particles being selected from polyethylene and nylon having an average molecular weight of from 50×10⁴ to 600×10⁴ and an average particle size of from 10 μm to 200 μm and preferably from 10 μm to 160 μm.

### BACKGROUND OF THE INVENTION

1. Field of the Invention

The present invention relates to vibration-damping technologies used for on-board and/or consumer-use audio equipment, video equipment, information-processing equipment, various precision equipment, and household electrical appliances such as a refrigerator. The present invention relates more specifically to a viscous-fluid-enclosing damper which can attenuate vibrations transmitted between a support and an object to be supported and to a vibration-damping composition which can be enclosed in the viscous-fluid-enclosing damper and can attenuate the transmitted vibrations by using the viscous resistance of a fluid having the composition.

2. Description of the Related Art

While rotating a disk at a high speed, a disk drive plays back recorded data from the disk by using non-contact reading means such as an optical pickup or a magnetic head. At that time, operation of the disk and/or non-contact reading means may generate internal vibrations. In addition, if an on-board and/or portable disk drive is used, external vibrations and shocks may also be generated during driving and/or when the disk drive is carried. When such internal vibrations and/or external vibrations and shocks exert effects on a mechanical chassis, a playback error which cannot be fixed by software means occurs. In order to prevent such a playback error from occurring, a viscous-fluid-enclosing damper is integrated between the mechanical chassis and a playback equipment housing to attenuate the vibrations. Japanese Unexamined Patent Application Publication No. 2007-154185 (Patent Document 1), for example, discloses such a viscous-fluid-enclosing damper.

### SUMMARY OF THE INVENTION

A viscous fluid enclosed in this viscous-fluid-enclosing damper constitutes a viscous vibration-damping composition having solid particles (i.e., a filler) such as silica powder dispersed in a viscous liquid such as silicone. However, the solid particles containing such inorganic matter have a relatively high specific gravity. Accordingly, their dispersion in the viscous liquid is insufficient. Thus, the particles precipitate in the vibration-damping composition, so that the vibration-damping properties of the composition are unstable. This results in an increasing demand for stability of the vibration-damping properties.

In view of the above, the present invention has been completed to meet such a demand. It is an object of the invention to provide a viscous-fluid-enclosing damper, whose fluid has stable vibration-damping properties and is resistant to changes over time, and a vibration-damping composition which is enclosed in the viscous-fluid-enclosing damper.

In order to achieve the above objective, the viscous-fluid-enclosing damper includes the following configuration.

Provided is a viscous-fluid-enclosing damper for damping vibrations transmitted between a support and an object to be supported through a viscous resistance of a vibration-damping composition, comprising a closed container enclosing the vibration-damping composition of the viscous fluid and being attached to the support and the object to be supported, wherein the vibration-damping composition comprises a viscous fluid comprising a viscous liquid having dispersed therein heat-resistant resin particles.

With regard to the viscous-fluid-enclosing damper, the closed container enclosing the vibration-damping composition of the viscous fluid is attached to the support and the object. Accordingly, the vibrations transmitted between the support and the object can be attenuated by the viscous resistance of the vibration-damping composition.

Meanwhile, the vibration-damping composition is a viscous fluid having heat-resistant resin particles dispersed in a viscous liquid. This characteristic makes particle deformation and dispersion state changes unlikely to occur and helps achieve a stable vibration-damping effect even if the composition is used at a high temperature and/or under conditions in which vibrations are repeatedly generated for a prolonged period.

The heat-resistant resin particles may have an average molecular weight of from 50×10⁴ to 600×10⁴. Since the heat-resistant resin particles have an average molecular weight of from 50×10⁴ to 600×10⁴, this configuration unlikely causes deformation and dispersion state changes of the heat-resistant resin particles in the viscous liquid and helps achieve a stable vibration-damping effect even if the composition is used at a high temperature and/or under conditions in which vibrations are repeatedly generated for a prolonged period.

In addition, the heat-resistant resin particles may have an average particle size of from 10 μm to 200 μm and preferably from 10 μm to 160 μm. Since the heat-resistant resin particles have an average particle size of from 10 μm to 200 μm and preferably from 10 μm to 160 μm, the particles are easily dispersed in the viscous liquid to achieve a stable dispersion system. Also, the resulting viscous fluid can have a desired viscosity.

The heat-resistant resin particles may be at least one type of resin particles selected from polyethylene and nylon. Since the heat-resistant resin particles are selected from polyethylene and nylon, a difference in the specific gravity between the viscous liquid and the heat-resistant resin particles can be small. This makes it possible to produce a stable viscous-fluid-enclosing damper.

It is also possible to produce a viscous-fluid-enclosing damper, the viscous fluid further including silica or calcium carbonate. Since inorganic particles such as silica or calcium carbonate are included in addition to the heat-resistant resin particles, those particles can become a dripping inhibitor (viscosity modifier) to produce a further stable viscous-fluid-enclosing damper.

The heat-resistant resin particles preferably have a melting point of 130° C. or higher. If the melting point is equal to or higher than 130° C., changes in the vibration-damping properties over time are unlikely to occur because the heat-resistant particles are stably dispersed in the viscous liquid when the viscous fluid is mixed and its temperature rises.

Also provided is a vibration-damping composition which can be used for the above viscous-fluid-enclosing damper. The vibration-damping composition may be a viscous fluid in which heat-resistant resin particles having an average molecular weight of from 50×10⁴ to 600×10⁴ are dispersed into a viscous liquid. Since the heat-resistant resin particles having an average molecular weight of from 50×10⁴ to 600×10⁴ are dispersed in the viscous liquid to prepare the vibration-damping composition, this configuration unlikely causes deformation and dispersion state changes of the heat-resistant resin particles in the viscous liquid and helps achieve a stable vibration-damping effect even if the composition is used at a high temperature and/or under conditions in which vibrations are repeatedly generated for a prolonged period.

In addition, the heat-resistant resin particles contained in the vibration-damping composition may have an average particle size of from 10 μm to 200 μm and preferably from 10 μm to 160 μm. Since the heat-resistant resin particles have an average particle size of from 10 μm to 200 μm and preferably from 10 μm to 160 μm, the heat-resistant resin particles can be easily dispersed in the viscous liquid to achieve a stable dispersion system. Also, the resulting viscous fluid can have a desired viscosity.

The heat-resistant resin particles may be at least one type of resin particles selected from polyethylene and nylon. The vibration-damping composition having the heat-resistant resin particles selected from polyethylene and nylon can reduce a difference in the specific gravity between the heat-resistant resin particles and the viscous liquid, and is therefore stable.

Such a vibration-damping composition may include a viscous fluid containing a viscous liquid having dispersed therein at least one type of heat-resistant resin particles and a dripping inhibitor, the particles being selected from polyethylene and nylon having an average molecular weight of from 50×10⁴ to 600×10⁴ and an average particle size of from 10 μm to 200 μm and preferably from 10 μm to 160 μm. It is preferable to produce a vibration-damping composition which can attenuate transmitted vibrations by using the viscous resistance of the fluid. As for the vibration-damping composition, the particles are stably dispersed in the viscous liquid, so that temperature changes and/or the vibrations unlikely induce changes over time.

Alternatively, such a vibration-damping composition for damping transmitted vibrations through a viscous resistance of a viscous fluid may include the viscous fluid containing a viscous liquid having dispersed therein at least one type of heat-resistant resin particles, the particles being selected from polyethylene and nylon having an average molecular weight of from 50×10⁴ to 600×10⁴ and an average particle size of from 10 μm to 200 μm and preferably from 10 μm to 160 μm. It is possible to produce a vibration-damping composition which can attenuate transmitted vibrations by using the viscous resistance of the fluid. In this vibration-damping composition, the viscous liquid having dispersed therein the particles can exert better vibration-damping performance.

Use of a viscous-fluid-enclosing damper and a vibration-damping composition which can be enclosed in the viscous-fluid-enclosing damper causes few changes in vibration-damping properties under vibration conditions, so that they are stable. In addition, they are hardly subject to temperature changes, and are stable after experiencing stringent temperature conditions and/or vibration conditions. Therefore, their vibration-damping performance has few changes over time.

### BRIEF DESCRIPTION OF THE DRAWINGS

FIG. 1 is a cross-sectional view of a viscous-fluid-enclosing damper according to an embodiment.

### DESCRIPTION OF THE PREFERRED EMBODIMENTS

The following describes in further detail a viscous-fluid-enclosing damper 11 and a vibration-damping composition which is a viscous fluid 12 included in the viscous-fluid-enclosing damper 11. In a disk drive having a built-in mechanical chassis, the viscous-fluid-enclosing damper 11 can attenuate vibrations transmitted between the mechanical chassis (an object to be supported) and a housing (a support) of the disk drive holding the mechanical chassis.

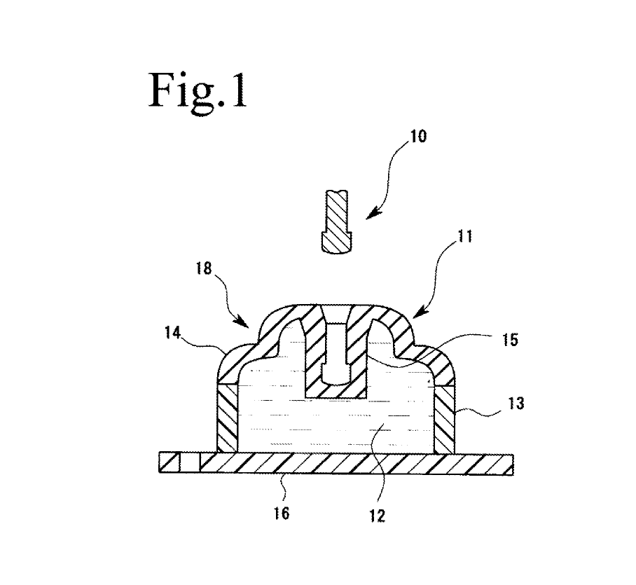

In the viscous-fluid-enclosing damper 11 as illustrated in the FIG. 1, a container body includes: a hard resin cylindrical peripheral wall section 13; a rubber elastomer flexible membrane section 14 attached to an edge of the peripheral wall section; and an agitating barrel section 15 holding a shaft 10 inserted thereinto. This container body is attached to a hard resin cover 16 to produce a closed container 18. In addition, this closed container 18 contains a vibration-damping composition which is a viscous fluid 12 having an effect on vibration damping.

The rubber elastomer is used to produce the flexible membrane section 14 and the agitating barrel section 15, and is prepared from a synthetic rubber and/or a thermoplastic elastomer (TPE). Examples of such a rubber elastomer can include: a synthetic rubber such as silicone rubber, urethane rubber, butyl rubber, chloroprene rubber, nitrile rubber, ethylene-propylene rubber; and thermoplastic elastomers such as a styrene-based TPE, an olefin-based TPE, a urethane-based TPE, and a polyester-based TPE.

A hard resin and/or a metal material can be used for the peripheral wall section 13 and/or the cover 16. However, in view of making their molding easy and making them light, a hard resin is preferably employed. It is particularly preferable to use a thermoplastic resin which can be used with the above rubber elastomer to integrate the components into one molded product. Required performance such as size precision, heat resistance, mechanical strength, durability, and reliability of specific members are considered. Also, it can be taken into consideration how to make them light and/or how to make them workable. Examples can include thermoplastic resins such as polyethylene resins, polypropylene resins, polyvinyl chloride resins, polystyrene resins, acrylonitrile-styrene-acrylate resins, acrylonitrile-butadiene-styrene resins, polyamide resins, polyacetal resins, polycarbonate resins, polyethylene terephthalate resins, polybutylene terephthalate resins, polyphenylene oxide resins, polyphenylene sulfide resins, polyurethane resins, polyphenylene ether resins, denatured polyphenylene ether resins, silicone resins, polyketone resins, and liquid crystal polymers. These resins can be used alone or as a composite. In addition, the size precision and heat resistance can be improved by adding fillers, such as a powder and/or fiber metal, glass, or filler, to these thermoplastic resins.

The viscous fluid 12 enclosed in the closed container undergoes viscous flow in the closed container in order to absorb vibration energy. Hence, it is required to possess a suitable viscosity, heat resistance, stability over time in the closed container, etc. In view of the above, the viscous fluid 12 is used in which a viscous liquid is mixed with solid particles that cannot dissolve into the viscous liquid.

More specific examples of the viscous liquid used can include: silicone oil such as dimethyl silicone oil, methylphenyl silicone oil, methyl hydrogen silicone oil, and fluorine-denatured silicone oil; poly-α-olefin-based oil, paraffin-based oil, polyethylene glycol-based oil; various mineral oil, plant oil, synthetic oil; and the like. Since a viscosity change due to temperature is small and heat resistance is excellent, a silicone-based oil is preferably used.

Heat-resistant resin particles are used for the solid particles, and have an average molecular weight of preferably from 50×10⁴ to 600×10⁴ and more preferably from 100×10⁴ to 350×10⁴. When the average molecular weight is lower than 50×10⁴, a value of their melt flow index becomes large, which causes deterioration of their heat resistance. In addition, when the average molecular weight exceeds 600×10⁴, their impact strength becomes weak, which causes quality of the heat-resistant resin particles to be somewhat unstable. As a result, the quality of the resin particles as a vibration-damping composition is susceptible to instability. If the range is from 100×10⁴ to 350×10⁴, the quality is better because their heat resistance is preserved at an ambient temperature under practical usage.

In addition, their average particle size is preferably from 10 μm to 200 μm and more preferably from 10 μm to 160 μm. When the average particle size is less than 10 μm, it is difficult to disperse them into the viscous liquid, so that their quality tends to be unstable. Further, when the size exceeds 200 μm, it is difficult to impart thereto a predetermined viscosity, so that a vibration-damping effect tends to be insufficient. Moreover, when the size is from 10 μm to 160 μm, their dispersion into the viscous liquid is good; the predetermined viscosity is easily obtained; and they are unlikely to change over time.

Examples of the heat-resistant resin particles include heat-resistant thermoset resins and thermoplastic resins such as polyethylene or nylon (e.g., nylon 6, nylon 12, and nylon 66). Polyethylene and nylon particles are preferable because their specific gravity is low and they are easily dispersed.

Of the polyethylene and nylon particles, polyethylene particles are preferably used. Mixing the particles with, for example, silica and/or calcium carbonate powder can keep their stability high and their viscosity can be easily adjusted.

As an index for the heat resistance of the heat-resistant resin particles, their melting point can be equal to or more than 130° C. When the melting point is lower than 130° C., there is a risk of the heat-resistant resin particles melting due to heat generated by mixing the viscous fluid. This melting point is measured in accordance with ASTM D2117.

Other solid particles can be added to the above given heat-resistant resin particles to the extent that desired dispersibility is not deteriorated or in order to improve their dispersibility or adjust their viscosity compared with when the heat-resistant resin particles are used alone. Examples can include an inorganic powder such as silicone resin powder, calcium carbonate powder, polymethylsilsesquioxane powder, wet silica particles, dry silica particles, glass beads, glass balloons, Zonolite of crystalline potassium silicate, basic magnesium sulfate, and kaolin of aluminum silicate; and those whose surface is treated with the above particles. They can be used alone or in combination, and may be mixed depending on the need.

Among the above solid particles, it is preferable to add silica and/or calcium carbonate powder which function as a dripping inhibitor (a viscosity modifier) for the above given heat-resistant resin particles.

A mixing ratio of the viscous liquid and the solid particles is a ratio by weight of about 30:70 to 70:30, preferably 60:40 to 40:60, and more preferably 55:45 to 45:55. A proportion of the solid particles other than the above given heat-resistant resin particles is 0 to 20% by weight.

Preferably, the solid particles are grains. It is less preferable that the solid particles are scale-like or bar-shaped particles. This is because grains are more stable in the viscous liquid and are unlikely to change over time. In addition, it is preferable to have as few pores as possible. Also, non-porous particles are preferred. This is because in a porous body, adsorption of the viscous liquid onto the solid particles increases and the amount of adsorption is readily subject to changes over time. Thus, stable characteristics are difficult to obtain.

The viscous-fluid-enclosing damper 11 made of these materials can be produced by a molding process such as two-color molding using a hard resin material and a soft elastomer. For example, the agitating barrel section 15 and the flexible membrane section 14, which are made of the above given rubber elastomer, and the peripheral wall section 13, which is made of the hard resin, are integrated by using, for example, two-color molding or insert molding to produce a container body. Then, the container body is filled with the viscous fluid 12. After that, the cover 16 is attached to the container body to seal the viscous fluid 12. The attachment between the container body and the cover 16 is preferably performed by ultrasonic fusion bonding because both the peripheral wall section 13 and the cover 16 are made of the hard resin.

### EXAMPLES

A viscous-fluid-enclosing damper was manufactured, including a closed container (18) with a diameter of 15 mm and a height of 10 mm as illustrated in the FIG. 1. A polypropylene resin was used for a peripheral wall section (13) and a cover (16). A styrene-ethylene.butylene-styrene block copolymer (hereinafter, abbreviated as “SEBS”) was used for a flexible membrane section (14) and an agitating barrel section (15). In addition, a vibration-damping composition in which the following viscous liquid and solid particles had been mixed was used as a viscous fluid (12) enclosed in the closed container (18). Afterwards, viscous-fluid-enclosing dampers having different vibration-damping compositions were prepared as Samples 1 to 8.

In Sample 1, 100 parts by weight of silicone oil, whose viscosity at 25° C. was about 20000 mPa·s and specific gravity was 0.974, as a viscous liquid and 60 parts by weight of high-density, high-molecular-weight polyethylene particles, whose average molecular weight was 200×10⁴, average particle size was about 30 μm, specific gravity was 0.94, and melting point was 136° C., as solid particles were mixed. Next, 5 parts by weight of silica as a dripping inhibitor was further added thereto and well mixed. Then, the resulting viscous fluid was used.

As for Sample 2, a viscous fluid was mixed and used in substantially the same manner as in Sample 1 except that high-molecular-weight polyethylene particles, whose average molecular weight was 50×10⁴, average particle size was about 110 μm, and melting point was 130° C., were used as a substitute for the solid particles of Sample 1.

As for Sample 3, a viscous fluid was mixed and used in substantially the same manner as in Sample 1 except that high-molecular-weight polyethylene particles, whose average molecular weight was 200×10⁴, average particle size was about 110 μm, and melting point was 130° C., were used as a substitute for the solid particles of Sample 1.

As for Sample 4, a viscous fluid was mixed and used in substantially the same manner as in Sample 1 except that high-molecular-weight polyethylene particles, whose average molecular weight was 350×10⁴, average particle size was about 150 μm, and melting point was 130° C., were used as a substitute for the solid particles of Sample 1.

As for Sample 5, a viscous fluid was mixed and used in substantially the same manner as in Sample 1 except that high-molecular-weight polyethylene particles, whose average molecular weight was 570×10⁴, average particle size was about 160 μm, and melting point was 130° C., were used as a substitute for the solid particles of Sample 1.

As for Sample 6, a viscous fluid was mixed and used in substantially the same manner as in Sample 1 except that nylon 12 particles, whose average molecular weight was 20000, average particle size was about 55 μm, and melting point was 185° C., were used as a substitute for the solid particles of Sample 1.

As for Sample 7, a viscous fluid was mixed and used in substantially the same manner as in Sample 1 except that low-density polyethylene particles, whose average molecular weight was 2×10⁴, average particle size was about 15 to 25 μm, and melting point was 105° C., were used as a substitute for the solid particles of Sample 1.

Then, those Samples were used to perform the following vibration characteristic test.

As for Sample 8, a viscous fluid was obtained and used in substantially the same manner as in Sample 1 except that a dripping inhibitor was excluded in Sample 1.

Then, this Sample was used to perform the following vibration characteristic test.

Vibration Characteristic Test: In order to support objects with a weight of 209 g by using three viscous-fluid-enclosing dampers, a vibration tester was assembled. Viscous fluid-enclosing dampers enclosing any of the above vibration-damping compositions of Samples 1 to 8 were installed on the tester. Then, this vibration tester was mounted on a shaking table. Next, temperature was switched from a room temperature (23° C.) to a high temperature (110° C.) and to a room temperature (23° C.). Under those temperature conditions, the tester was shaken vertically (i.e., in a z axis direction) at a constant acceleration of 9.8 m/s² (1 G) and a frequency in a range from 7 Hz to 200 Hz to determine a resonance frequency f₀ (Hz). The acceleration a1 of the housing and the acceleration a2 of the object to be supported were determined at a resonance frequency f₀ (Hz). A relation 20 Log (a2/a1) was used for conversion to calculate a resonance magnification Q (dB). The following Table 1 shows the results.

TABLE 1

| | | Room | | −> Room | |
|---|---|---|---|---|---|
| | | Temperature | −> | Temperature | Change |
| | | (23° C.) | 110° C. | (23° C.) | Rate |
| f₀ (Hz) | Sample 1 | 13.5 | 10.5 | 13.5 | 0% |
| | Sample 2 | 13.0 | 10.5 | 13.0 | 0% |
| | Sample 3 | 13.0 | 10.5 | 13.0 | 0% |
| | Sample 4 | 12.5 | 10.5 | 12.5 | 0% |
| | Sample 5 | 12.5 | 9.5 | 12.5 | 0% |
| | Sample 6 | 14.5 | 10.5 | 14.5 | 0% |
| | Sample 7 | 13.5 | 7.0 | 85.0 | +529% |
| | Sample 8 | 11.5 | 9.0 | 11.5 | 0% |
| Q (dB) | Sample 1 | 2.47 | 5.84 | 2.42 | −2% |
| | Sample 2 | 2.43 | 5.98 | 2.31 | −5% |
| | Sample 3 | 2.36 | 5.76 | 2.27 | −4% |
| | Sample 4 | 2.49 | 5.28 | 2.47 | −1% |
| | Sample 5 | 2.50 | 5.34 | 2.51 | −1% |
| | Sample 6 | 2.57 | 5.76 | 2.56 | −1% |
| | Sample 7 | 2.27 | 12.35 | 1.53 | −33% |
| | Sample 8 | 2.42 | 5.88 | 2.43 | 0% |

In any of Samples 1 to 6 and 8, the resonance magnification Q and the resonance frequency f₀ had almost no changes and thus were stable. This demonstrated almost no changes in vibration-damping performance. In contrast, in Sample 7, the resonance magnification Q and the resonance frequency f₀ markedly changed and its vibration-damping performance was altered over time.

Note that the above embodiments are just an example of the present invention. The present invention is not limited to such embodiments. Any modified embodiment should be included in an extent not departing from the scope of the present invention. For example, any shapes of known viscous-fluid-enclosing dampers can be allowed for the shape of the viscous-fluid-enclosing damper 11. Examples can include: a viscous-fluid-enclosing damper without a resin peripheral wall section; and a viscous-fluid-enclosing damper having a shaft connection section where an agitating barrel section 15 hardly protrudes inwardly into the damper.

What is claimed is:

1. A viscous-fluid-enclosing damper for damping vibrations transmitted between a support and an object to be supported through a viscous resistance of a vibration-damping composition, comprising:
a closed container enclosing the vibration-damping composition of the viscous fluid and being attached to the support and the object to be supported,
wherein the vibration-damping composition comprises a viscous fluid comprising a viscous liquid having dispersed therein heat-resistant resin particles.

2. The viscous-fluid-enclosing damper according to claim 1, wherein the heat-resistant resin particles have a melting point of 130° C. or higher.

3. The viscous-fluid-enclosing damper according to claim 1, wherein the heat-resistant resin particles are at least one type of resin particles selected from polyethylene and nylon.

4. The viscous-fluid-enclosing damper according to claim 1, wherein the heat-resistant resin particles have an average molecular weight of from 50×10⁴ to 600×10⁴.

5. The viscous-fluid-enclosing damper according to claim 1, wherein the heat-resistant resin particles have an average particle size of from 10 μm to 200 μm and preferably from 10 μm to 160 μm.

6. The viscous-fluid-enclosing damper according to claim 1, wherein the viscous fluid further includes silica or calcium carbonate.

7. A vibration-damping composition for damping transmitted vibrations through a viscous resistance of a viscous fluid, comprising:
the viscous fluid comprising a viscous liquid having dispersed therein at least one type of heat-resistant resin particles, the particles being selected from polyethylene and nylon having an average molecular weight of from 50×10⁴ to 600×10⁴ and an average particle size of from 10 μm to 200 μm and preferably from 10 μm to 160 μm.

8. A vibration-damping composition according to claim 7, wherein the viscous fluid comprises a viscous liquid further having dispersed therein a dripping inhibitor.
